(19) United States
(12) Patent Application Publication
(10) Pub. No.: US 2004/0090418 A1
(43) Pub. Date: May 13, 2004

(54) Joystick with axial disengagement switch

(75) Inventors: Jeff Ceremony, Fairfield, CA (US); Robert King, Greenbrae, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Bio-Rad Laboratories, Inc., a Corporation of the state of Delaware, Hercules, CA (US)

(21) Appl. No.: 10/293,917

(22) Filed: Nov. 12, 2002

(51) Int. Cl. G09G 5/08

(52) U.S. Cl. 345/161

(57) ABSTRACT

A joystick is constructed to include a handle that is capable of both pivotal movement and axial movement, the pivotal movement serving the conventional function of a joystick and the axial movement serving to engage and disengage the joystick to the electronic components that translate the joystick position to the position of a moving part in an electronically controlled apparatus. Thus, in its normal fully extended position, the joystick is activated and functioning whereas the activation can be suspended and the joystick repositioned by simply pushing on the joystick handle along the axis of the joystick. This activating and deactivating capability is achieved with no external buttons on the joystick shaft.

### BACKGROUND OF THE INVENTION

1. Field of the Invention

This invention resides in the field of joystick design and operation.

2. Description of the Prior Art

Joysticks, although commonly known for use with computers and recreational devices, are also widely used in the laboratory for both micro-scale manipulations. Hanging joysticks are manipulated from below, while upright joysticks extend upward and are manipulated by grasping and moving the knob at the upper end of the joystick. Examples of systems in which a hanging joystick is preferred over an upright joystick are micromanipulator systems and pressure injector systems used in biotechnology and electrophysiology. Micromanipulator systems provide microscopic and precise manipulation of specimens for the performance of clinical and laboratory procedures, such as for example in vitro fertilization, intracytoplasmic sperm injection, and other pronuclear and blastocyst injection procedures. The fact that the joystick is suspended from above and manipulated from below provides optimal ergonomics and user comfort during long periods of use. The user can comfortably “hang” on the joystick for extended periods of time, and the risk of accidental movement is minimized. Upright joysticks find use in laboratory instrumentation as well, and the user can likewise comfortably rest on an upright joystick for extended periods of time.

The range of motion of any joystick, hanging or upright, is limited, and the joystick must be deactivated and reactivated if the degree of movement needed for the component that the joystick is controlling is greater than the range of the joystick. To provide this capability, joysticks are typically equipped with a clutch that is operable by pressing a button on the shaft of the joystick. Unfortunately, the manipulation of the button interferes with the user's control of the joystick itself

### SUMMARY OF THE INVENTION

A joystick has now been devised that is functionally engaged with, and disengaged from, a joystick module, by an axial movement of the joystick handle. The handle is thus capable of movement both pivotally relative to the support from which it is suspended and axially along the axis of the handle itself, the pivotal movement being translatable into electronic signals that are transmitted to the moving component of the system being controlled by the joystick, for example the injector or positioning component of the system, and the axial movement operating a switch or clutch that activates or deactivates the connection between the pivotal handle movement and the electronic signals. In preferred embodiments, the joystick has a z-direction movement as well, i.e., an angular rotary movement that can also be used for positioning. In accordance with the present invention, the handle is lifted or pushed upward along its axis to prevent the pivotal or angular movement of the joystick from being translated into the electronic signals that produce positioning in the apparatus to which the joystick is connected. Once the handle is returned to its normal, lowered position, the handle is once again re-engaged with the joystick module and the joystick position is once again translated into the position of the moving component in the system. Alternatively, the handle can be configured for activation and deactivation by reverse movement, i.e., moving the joystick downward to interrupt the connection and thereby block translation of the joystick movement into electronic signals and returning the joystick back upward to resume the connection. Either alternative can be applied to both hanging and uprights joysticks. In all cases, however, the handle contains no external buttons, either on its end or side. In preferred embodiments, the handle contains a spring or similar biasing means that maintains the handle in the position in which the joystick is electronically engaged with the joystick module in the absence of manual pressure along the axis of the handle.

For upright joysticks, it is preferred that the joystick be deactivated by pulling up on the joystick and thereby extending the handle, and activation is return by releasing the joystick and thereby contracting the handle. In hanging joysticks, the action and effect are the same: deactivation is preferably achieved by pushing up on the handle from below (i.e., contracting the handle), and activation by releasing the handle to its lowered position (i.e., extending the handle).

Other features and embodiments of the invention will be apparent from the description that follows.

### BRIEF DESCRIPTION OF THE DRAWINGS

FIG. 1 is a cross section of a hanging joystick representing one example of the present invention.

### DETAILED DESCRIPTION OF THE INVENTION AND SPECIFIC EMBODIMENTS

While the invention is susceptible of a variety of constructions and forms of implementation, the basic concepts of the invention can be understood by a detailed examination of one embodiment. Such an embodiment is shown in the attached drawings and described below.

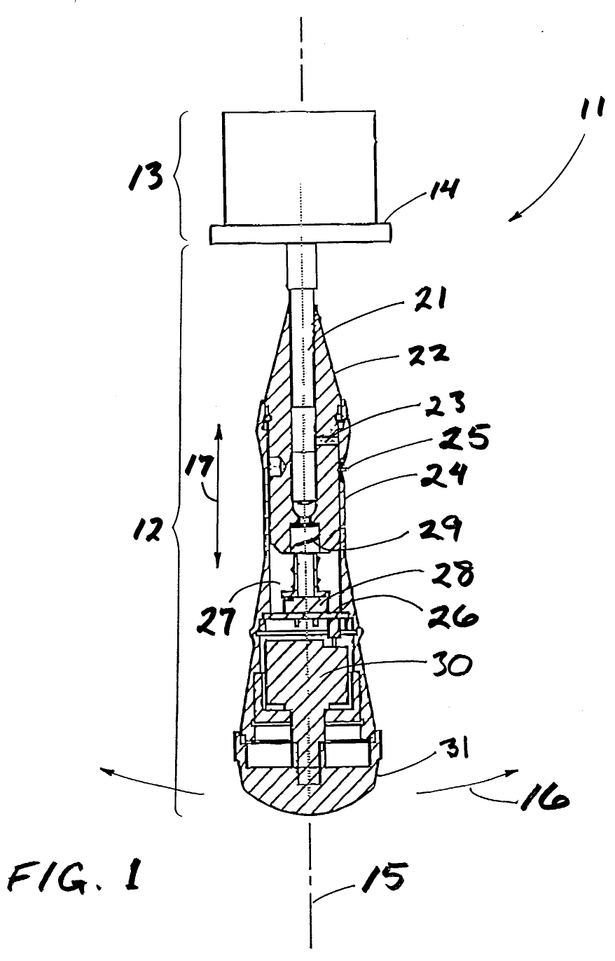

The joystick shown in FIG. 1 includes a handle 12 and a joystick module 13. The module is a common item readily available from joystick suppliers and manufacturers, such as for example CH Products of Vista, California, USA. The module contains sensors, electrical connections and other common electronic elements that translate the back-and-forth movement of the joystick into signals that are sent to the overall system to control the movement of the positioning component. The module is attached to a joystick support 14 that serves as a mechanical support for the handle 12. The support permits the electrical connections between the handle 12 and the module 13. The handle is elongated and has a central axis 15. The mechanical connection between the handle 12 and the support 14 allows for pivoting movement of the handle within a radius around the handle axis 15 as represented by the arrows 16. Although the range of movement shown only as an arc in the Figure, it is understood that the handle can be pivoted in any direction about the axis 15.

The axial movement of the handle is shown by the arrow 17. As is visible in this cross section view, the handle is constructed in several components. At the center of the handle is a central joystick shaft 21 which is pivotally mounted directly to the support 14 and is not capable of axial movement. Secured to the exterior of the shaft is a center mount 22 that is fixed relative to the shaft by set screws 23. A sleeve 24 encircles the center mount 22, the sleeve being movable up and down in the direction of the arrow 17 over the exterior of the center mount 22. A travel stop 25 protruding from either the sleeve 24 or the center mount 22 limits the travel of the sleeve.

The interior of the sleeve contains a transverse platform 26, and the platform, the walls of the sleeve, and the lower end of the center mount 22 together form a cavity 27 in the handle interior. Secured to the platform 26 is a momentary switch 28, one portion of which moves with the sleeve 24 when the sleeve is slid up and down over the center mount 22. A coil spring 29 urges the momentary switch 28 and hence the entire sleeve 24 downward and is placed under tension (compressed further) when the sleeve 24 is pushed upward. Although the electrical connections between the momentary switch 28 and the module 13 are not shown, the momentary switch and the connections to the module are such that module remains activated (and hence the lateral pivoting movements of the handle are translated within the module to directional electronic signals) as long as the sleeve 24 is in the position furthest downward, i.e., when the handle is extended to its fullest extent. Deactivation of the module occurs when the sleeve 24 is pushed upward, i.e., when the handle is in its contracted position.

Other components in the handle interior include a z-axis component 30 that responds to rotation of the knob 31 by sending an appropriate impulse to the joystick module. Actuation of the z-axis component can be controlled by the momentary switch as well.

Although not shown, an upright joystick can be constructed with the same components except for a reverse-mounted momentary switch to achieve the opposite effect, i.e., the switch can be arranged and connected such that actuation of electrical connections between the handle and the joystick module is achieved by pulling up on the handle. The spring can likewise be rearranged to bias the handle in a downward or contracted position.

The foregoing is offered primarily for purposes of illustration. Further variations in the materials, additives, operating conditions, and equipment that are still within the scope of the invention will be readily apparent to those skilled in the art.

We claim:

1. A disengageable joystick comprising an elongate handle mounted from a joystick support, said handle being manually manipulatable by pivoting relative to said joystick support and by axial movement between a contracted position and an extended position, said joystick support comprising actuator means for generating electrical signals in response to said pivoting manipulation of said handle, and switch means for functionally disengaging said handle from said actuator means when said handle is in one of said contracted and extended positions and functionally engaging said handle from said actuator means when said handle is in the other of said positions.

2. A disengageable joystick in accordance with claim 1 in which said joystick is a hanging joystick and said elongated handle depends vertically downward from said joystick support.

3. A disengageable joystick in accordance with claim 2 further comprising spring means for biasing said handle toward said extended position.

4. A disengageable joystick in accordance with claim 1 in which said switch means is a momentary switch housed in said handle.

5. A disengageable joystick in accordance with claim 1 in which said handle comprises a shaft that is not axially movable relative to said joystick support and a sleeve slidably mounted over said shaft between a raised position and a lowered position, said disengageable joystick further comprising spring means inside said sleeve and engaging said sleeve and said shaft for biasing said sleeve toward one of said raised and lowered positions.

6. A disengageable hanging joystick in accordance with claim 5 in which said switch means is a momentary switch, said disengageable hanging joystick further comprising a cavity in said handle, bounded by said shaft and said sleeve and retaining said switch means and said spring means.
